(19) United States
(12) Patent Application Publication
(10) Pub. No.: US 2014/0188442 A1
(43) Pub. Date: Jul. 3, 2014

(54) System and Method for Selecting Predictors for a Student Risk Model

(71) Applicant: PEARSON EDUCATION, INC., Upper Saddle River, NJ (US)

(72) Inventors: Anne T. Zelenka, Denver, CO (US); Andrew J. Sannier, Denver, CO (US); Brian Alexander, Greenwood Village, CO (US)

(73) Assignee: PEARSON EDUCATION, INC., Upper Saddle River, NJ (US)

(21) Appl. No.: 13/727,901

(22) Filed: Dec. 27, 2012

(51) Int. Cl. G06F 17/50

(52) U.S. Cl. CPC G06F 17/5009
USPC 703/2

(57) ABSTRACT

Systems and methods may automatically generate institution-specific, program-specific or course-specific student risk assessment models from an arbitrary set of potential risk predictors. Student data from previously completed courses are collected and used to create a design matrix of predictor values and an outcome vector. The system determines the coefficients for the model using an automated predictor selection method, such as lasso logistic regression. The system uses the model with current student data to assess an outcome probability, such as the risk of a current student from failing or dropping a course. In addition to an overall risk assessment model, component models focused on particular components of risk, such as performance, participation, attendance, timeliness, or student profile, can be generated. The component models may be used along with the overall risk assessment model to help explain the reasons behind the risk assessment.

### FIELD OF THE INVENTION

This invention relates generally to creating a model for assessing student risk, and more particularly to selecting predictors for a model for assessing student risk from an arbitrary set of potential predictors and providing component models to explain such risk.

### BACKGROUND

A student's successful completion of a degree or other course of study depends upon their ability to successfully complete individual courses. Student behavior and achievement in an individual course may be monitored and used to determine whether the student is at risk of failing or dropping a course. Once a student is identified as at risk of failing or dropping a course, then it is possible to intervene to try and reduce the risk and assist the student in successfully completing the course.

Current methods of identifying students at risk of failing or dropping a course may use heuristics, such as poor grades early in the course, failure to submit assignments on time, or inadequate time spent interacting with course materials. Typically these heuristics are developed using human judgment rather than through the analysis of student behavior and performance data.

Other methods of assessing student risk use predictive analytics. These methods can learn risk patterns from historical data, combine information from multiple predictors, and produce probabilities of failure as output. The output from these methods may be limited to assigning a student a category of risk, such as high risk, medium risk, or low risk without further explanation of why a student falls within a particular risk category. Some methods are limited to looking at data at a single point in time, such as two weeks into a course term. One drawback of these methods is that they require custom development to account for the unique risk patterns associated with a specific institution or even a specific course. Typically, a skilled statistician manually fits and tunes the model by selecting the appropriate predictors and higher order polynomial terms or interactions between predictors to create an institution-specific or course-specific model. To extend the model to other institutions or courses requires that the model be manually fit and tuned to account for the unique risk patterns associated with the other institutions or courses.

Thus, there is a need for a method that more automatically accounts for institution-specific and course-specific features and that can generate a model or a set of risk estimating equations that work for different courses and different institutions. In addition, there is a need for a method that assesses risk throughout the course term, not just at a predetermined point in the course term.

### SUMMARY

Aspects of the invention are directed to automatically generating institution-specific, program-specific or course-specific risk models from an arbitrary set of potential risk predictors. Student data from previously completed courses are used to train a model. The student data may be collected from any system that includes student data. The student data is associated with a number of risk predictors. Each risk predictor is defined in a similar way to accommodate additional and/or new predictors. The system builds a design matrix using the historical student data. In some instances, the data is transformed prior to entry in the matrix. In other instances where the student data is associated with a predictor that has a type of factor, the predictor is expanded before being added to the design matrix. The matrix may also include interaction terms to account for n-way interactions between predictors. The system also builds an outcome vector that indicates the success or failure of each of the students in each of the courses represented in the historical student data. The system determines the coefficients for the model using an automated predictor selection method, such as lasso logistic regression. Each coefficient is associated with a predictor. The relative values of the coefficients indicate the relative importance of the predictor or interaction term to the assessment of risk. The system uses the model with current student data to assess the risk of a current student from failing or dropping out of a course.

In addition to an overall risk assessment model, the system can generate component models that are focused on a particular component of risk, such as performance, participation, attendance, timeliness, and student profile. The component models may be used along with the overall risk assessment model to help explain the reasons behind the risk assessment.

These illustrative aspects and features are mentioned not to limit or define the invention, but to provide examples to aid understanding of the inventive concepts disclosed in this application. Other aspects, advantages, and features of the present invention will become apparent after review of the entire application.

### BRIEF DESCRIPTION OF THE DRAWINGS

These and other features, aspects, and advantages of the present disclosure are better understood when the following Detailed Description is read with reference to the accompanying drawings, where:

FIG. 1 is a block diagram that illustrates exemplary components used to create and deploy a model for assessing student risk,

FIG. 2 illustrates an exemplary set of risk predictors,

FIG. 3 is a flow diagram illustrating an exemplary method for creating a model for assessing student risk,

FIG. 4 is an exemplary dashboard page illustrating risk assessments for a number of courses,

FIG. 5 is an exemplary dashboard page illustrating risk assessments for a selected course,

FIG. 6 is an exemplary dashboard page illustrating additional information regarding students in a selected risk category for the selected course illustrated in FIG. 5, and

FIG. 7 is an exemplary page illustrating additional information regarding a selected student in the selected risk category illustrated in FIG. 6.

### DETAILED DESCRIPTION

Aspects of the invention are directed to automatically generating institution-specific, program-specific or course-specific risk models. The generation of the models includes the use of automated logistic regression to select risk predictors from an arbitrary set of potential risk predictors, including interactions between predictors. A risk predictor is any information that may be predictive of a probability of a particular outcome, such as the probability of a student failing or dropping a course. Exemplary predictors include, but are not limited to the number of points earned by a student, the number of assignments submitted after the deadline, the point in time in the course term, the number of days the student has logged in since the course began, the course, and the prior academic history of the student. Predictor information or values may be obtained from a learning management system (LMS) or from another system that stores student information. Other aspects of the invention are directed to generating component models which help explain the reasons behind a student's risk assessment.

### Exemplary Operating Environment

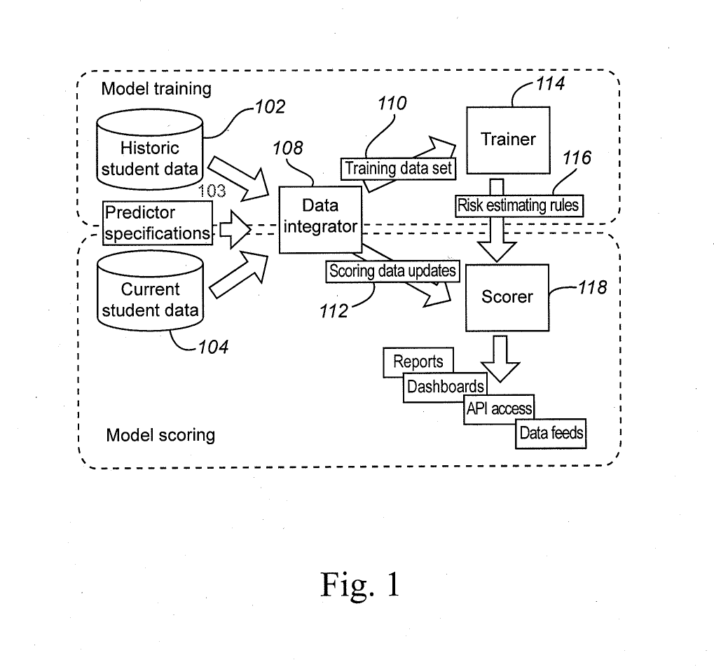

FIG. 1 illustrates an exemplary operating environment for the model training function and the model scoring function. Both functions use student data. In one example, the student data is available from an LMS, such as the LearningStudio LMS available from Pearson Education. Alternatively, the student data may be provided by another LMS or may be available from other sources. The historic student data 102 includes student data for courses that have been completed, whereas the current student data 104 includes student data for courses that are currently in progress. The model training function uses historical student data 102, while the model scoring function uses current student data 104. The student data is collected and processed by the data integrator 108. The data integrator may organize or process the collected data in a particular manner that makes the training and/or scoring functions more effective. The data integrator generates a training data set 110 for the trainer 114 and generates a scoring data set 112 for the scorer 118.

The trainer 114 determines which predictors to use in the model and generates a model 116 that includes equations, rules, formulas, or other means to estimate an outcome probability, such as a student's probability of failing or dropping a course. The model is used by the scorer 118 to assess student risk. The scorer 118 applies the model to the scoring data set 112 and provides an output that indicates the calculated outcome probability of student risk. The output may be provided via a report or dashboard or may be provided to other systems or system components through an API or a data feed.

In addition to the risk assessment model, the trainer 114 may also create component models that are related to a particular aspect of risk, such as performance, participation, attendance, timeliness, or student profile (i.e., student information that is not from the current course, such as past successes/failures). The trainer uses a similar method to that used for the risk assessment model to generate a component model, but instead of using all of the predictors it only uses those predictors that are related to a particular aspect of risk. Once a component model is available, the scorer 118 applies the component model to the scoring data set 112 and provides an output that indicates the calculated component risk. The output may be provided along with the calculated student risk to help explain the reasons for the student's risk assessment.

The components shown in FIG. 1 may be implemented in software and/or hardware and may operate on one or more computer systems. In one implementation, the models and component models are stored on a computer system remote from a user's system and are accessed via a web service API, dashboard or the like. The systems may be interconnected via a network, such as the Internet, one or more intranets, wide area networks (WANs), local area networks (LANs), and the like, portions or all of which may be wireless and/or wired. The student data used for training and the student data used for scoring may come from the same system or from different systems.

The computer system or systems are not limited to any particular hardware architecture or configuration. A computer system may include one or more computing devices and can include any suitable arrangement of components that provide a result conditioned on one or more function calls. Suitable computing devices include multipurpose microprocessor-based computer systems accessing stored software that programs or configures the computing system from a general-purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device. The computing device may execute code or other instructions stored in a data store or on a computer-readable medium including, but not limited to: random access memory (RAM), read-only memory (ROM), hard drive, solid-state drive, USB flash drive, memory card, optical disc such as compact disc (CD) or digital versatile disc (DVD), floppy disk, or magnetic tape. Memory includes both volatile and nonvolatile memory and data storage components.

### Predictors

The student data may include data collected by an LMS, as well as data collected by other means. In one example, the data collected by an LMS includes data related to the following: course code, course, student history, enrollment, and enrollment day. The course code identifies the course subject and a number or level. For example, a course code of MAT 100 may identify math as the course subject based on “MAT” and the course as a first-year or first-level course based on “100”. The course identifies a particular course section and is associated with a course ID. There may be multiple courses associated with the same course code. Student history includes information about a student's performance in prior terms. Enrollment identifies a particular student enrolled in a particular course. A student may be enrolled in multiple courses and a course may have multiple enrollments. Enrollment day includes information about student performance and activity for a particular student for a particular day in a particular course. For example, an enrollment day may include information about points earned, logon activity, and posting activity for a particular student for a particular day of the course.

To allow the system to work with an arbitrary number of predictors and to allow different, additional and/or new predictors, each predictor may be specified using the same or similar types of information. In one implementation, predictors are specified using the information in Table 1. The predictor specification information may be provided in a predictor specification table 103, as shown in FIG. 1. The predictor specification information may be different for different implementations and in some instances a data analyst may be permitted to modify the table to add or remove predictors or to change a characteristic of a predictor.

The system uses the predictor specification information related to “component” to associate the predictor with the appropriate component model. The system uses the predictor specification information related to “transformation” to process the data associated with the predictor. In some instances the data is processed so that rather than a raw number, the data reflects a relative value, such as a deviation from an average or mean.

TABLE 1

| Predictor Information | Comments |
|---|---|
| Term length | Number of days in course |
| Course code | Course subject and level |
| Predictor level | Level associated with predictor, e.g., course, |
| | enrollment, enrollment-day, or student history |
| Column name | Predictor name as specified in the table in |
| | which the predictor is found |
| Display name | Predictor name as it should be displayed in the |
| | user interface |
| Type | Type of predictor, e.g., factor or numeric, |
| | where numeric includes continuous, integer, |
| | decimal, and binary |
| Component | Component to which predictor applies, e.g., |
| | performance, participation, timeliness, |
| | attendance, student profile |
| Transformation | Transformation of predictor value, e.g., daily |
| | average through course, daily average over |
| | past seven days, sum for past seven days, |
| | number days variable has been non-zero, flag— |
| | specify a logical operation to produce a 1 |
| | (TRUE) or 0 (FALSE), centering—subtract an |
| | average from the value so as to account for |
| | differences, center by current section, center by |
| | historic course code average |

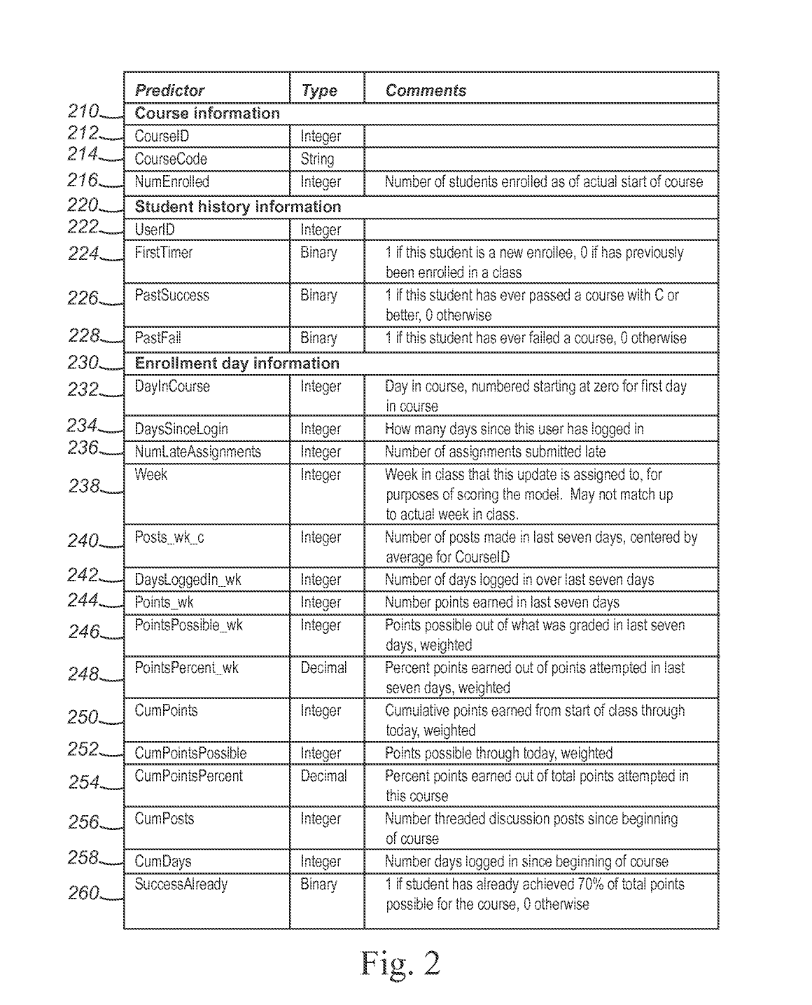

FIG. 2 illustrates an exemplary set of predictors collected by the data integrator. The training data includes predictors related to course information 210, student history information 220, and enrollment day information 230. The course information predictors include a course ID 212, a course code 212, and the number of students enrolled at the start of the course 216. The student history information predictors include a user ID 222, which identifies a student, an indication of whether the student is a new enrollee in the course, and indications of past course success 226 or failure 228. The enrollment day information predictors include information about the point in time in the course 232, 238, as well as information about student log-ins 234, 242, 258, late assignments 236, points 244, 246, 248, 250, 252, 254, 260, and other student activity 240, 256. The specific data provided to the data integrator that may predict student risk is not limited to that illustrated in FIG. 2. The system is designed to work with any data that may be predictive of student risk. There may be different amounts or different types of data than that illustrated in FIG. 2.

If there are multiple courses associated with the same course code, then the data for those courses may be combined in a training or scoring data set. Once the data integrator creates the training or the scoring data set, it stores it and provides it to the trainer or scorer. The data sets created by the integrator may be used for purposes other than training and scoring.

### Trainer

The trainer receives the training data set from the data integrator and creates a design matrix. The matrix includes a row for every enrollment day record for a set of courses and a column for each predictor. Each enrollment day record identifies a course, a student, and a day in the course. The set of courses may include courses associated with the same course code. For example, if there are four courses associated with MAT 100, then data for those four courses may be part of the matrix. Using records based on an enrollment day allows the creation of a model that can assess student risk at any point during the course term.

The trainer may transform the predictor data prior to including it in the matrix. For example, the trainer may average the data, aggregate the data, or scale the data by comparing it to an average, mean, or standard deviation. Transformation is used in some instances to help ensure that the regression coefficients are of comparable size. In other instances the data may be transformed because it is only relevant to one particular course. If so, then the data is transformed so that it is only used for that course. One example of this is data related to threaded discussions since different instructors may incorporate threaded discussions into their courses in different ways. The trainer may use the transformation information provided in the predictor specification table to appropriately transform predictor data. Typically, the matrix includes a column for each predictor value with a type of numeric.

The trainer may also expand the predictor data prior to including it in the matrix. If a predictor has a type of factor, then the trainer expands the predictor into dummy or indicator variables and includes a column for each indicator variable in the matrix. Each indicator variable is assigned a value that represents a level of the factor. There are a finite number of factor levels. In one example, there are sixteen weeks in a course and the predictor that identifies the week in the course is a factor variable. The week in the course may be identified by a number between 1 and 16. The trainer expands the predictor data into 15 indicator variables that represent weeks 2-16. Each indicator variable is assigned a value of zero or one (one of the two factor levels), where one indicates the selected week. An indicator variable is not needed for week 1 since week 1 is indicated when all of the values for weeks 2-16 are zero.

The trainer may also include columns for interaction terms in the matrix. The system can accommodate any number of interactions between predictors. In one example where two-way interactions are used the trainer multiplies the values in two different columns to generate an interaction term. The number and content of the columns of the design matrix may vary based on the type of automated feature selection used. For example, although scaling is used for lasso logistic regression, it may not be used for other techniques. Other techniques may include other types of columns, including but not limited to, columns for polynomial terms.

The trainer also creates an outcome vector. The outcome vector is essentially a column of outcome values. There is one outcome value for each enrollment day record. The outcome values reflect the success or failure of the students in the courses represented in the historical student data.

The trainer uses the design matrix and the outcome vector to create a risk model or a set of mathematical equations to assess student risk. The trainer may use an automated feature selection technique to create the model. Automated feature selection techniques include automated logistic regression techniques that include, but are not limited to, lasso logistic regression, forward step-wise regression, and backward step-wise regression. Using an automated logistic regression technique provides the benefits of logistic regression without requiring manual fitting and tuning of the model for different institutions, programs, or courses. The benefits of logistic regression include producing risk estimating equations that are easy to deploy in the scorer and to incorporate into other software, providing explanations of the levels of risk, estimating the probability of the event of interest occurring, and estimating relatively quickly even on large data sets.

Logistic regression can be used to predict binary outcomes, such as a student's success or failure at the end of a course term. Equation (1) illustrates a model for estimating the probability that a particular case will take on a value of one.

Pr(yᵢ=1)=logit⁻¹(β₀+Σⱼ₌₁^{p}xᵢⱼβⱼ) (1)

where yᵢ is the outcome for case i, xᵢⱼ is the value of predictor j for case i. The regression coefficients β₀ through βₚ are chosen using some criterion such as maximum likelihood, which maximizes the likelihood of seeing the observed data under the selected model. The logit function is defined as:

$$logit ( x ) = log ( \frac{x}{1 - x} ) \qquad ( 2 )$$

and the inverse logit is defined as

$${logit}^{- 1} ( x ) = \frac{{e}^{y}}{1 + {e}^{y}} \qquad ( 3 )$$

Logistic regression models, like other regression models, can suffer from overfitting when selected coefficients pick up on random noise in the observed data, leading to poor predictions on new data. Regularized regression seeks to ameliorate this problem by maximizing the regression optimization function subject to a constraint that limits the size of the regression coefficients.

With L1 regularized logistic regression, also known as lasso logistic regression, a penalized version of the logistic regression maximization function is maximized.

max_{β}_{₀}_{,β}_{₁}Σᵢ₌₁^{N}[yᵢ(β₀+Σⱼ₌₁^{p}x_{i,j}βⱼ)−log(1+e^{β}^{₀}^{+Σ}^{ⱼ₌₁}^{^{p}}^{x}^{ᵢⱼ}^{β}^{ⱼ})]−λΣⱼ₌₁^{p}|βⱼ| (4)

Here, the penalty is constructed as the sum of the absolute value of the regression coefficients (the βⱼ) multiplied by a regularization parameter λ. The intercept term β₀ is not penalized. The predictors xᵢ are typically standardized so that the values of βⱼ are of relatively meaningful sizes. In one implementation the trainer uses the R package glmnet to determine the coefficients for a lasso logistic regression model, as set forth in Jerome Friedman, Trevor Hastie, and Robert Tibshirani, Regularization Paths for Generalized Linear Models via Coordinate Descent; Journal of Statistical Software, 33(1), 1-22 (2012). Lasso logistic regression shrinks many regression coefficient values to zero, which essentially drops the corresponding predictors from the model. Once the coefficient values are determined via equation (4), they are substituted into equation (1) to create a model.

The trainer selects the regularization parameter, λ, using cross-validation to avoid over fitting the regularization parameter to one sample. The trainer divides the training set into k subsets. The model is trained on a training set consisting of all but one of the k subsets and then an error criterion is calculated from model predictions made using the held-out subset. The regularization parameter giving the lowest average error criterion is selected for the model. In one example, the trainer uses three-fold cross validation with deviance to quantify the error.

The training data set includes correlated data, such as data for the same student for different enrollment days or data for the same student for multiple courses. The correlated data may also include data associated with different courses at the same level, such as multiple first-year courses. Since correlated data can distort the training process, the system randomly samples courses rather than individual enrollment day records so that all enrollment day records for a particular course are placed in the same cross-validation sample.

Early in the course term, a student may not have earned any points. Since a glmnet-estimated regression model may drop a record with missing data, it may drop a record from early in the course term that does not include points information even though there was no opportunity for the student to earn points at that point in the course term. To account for this possibility the trainer may create a model that can assess risk without having to use points as a predictor. However, since points may be a strong predictor later in the course term, the trainer may create a second model that uses points that can be used once the student attempts to earn points. Having two models allows the scorer to more accurately assess risk at any point in the course term.

To verify the model, the historical student data may be split into two data sets prior to training so that one data set may be used to compute classification errors once a model is created. In one example, the trainer computes errors on a week by week basis, even though the data set is based on days since a week-based error provides a good sense of the classification accuracy of the model without providing too much detail. Classification accuracy is characterized by overall accuracy, such as the proportion of cases in the test set that are correctly classified by the model, precision, such as the proportion of true positives out of the sum of true positives and false positives, and recall, such as the proportion of true positives out of the sum of true positives and false negatives. The F1 score or F-measure may be calculated as the harmonic mean of precision and recall. This provides a one-number summary that can be used to compare different models.

Once the model is created it is stored for later use by the scorer. In addition, to storing the model, the trainer also stores an object that specifies the data model of the data set that was used for training, as well as the mean and standard deviation for each predictor that requires scaling.

### EXAMPLE

A simplified example may serve to further illustrate the creation of the design matrix and the outcome vector, and the determination of coefficients for a risk assessment model. In this example, four predictors are used: 1) week in course, 2) cumulative proportion points earned out of cumulative points attempted, 3) proportion days logged in, and 4) average posts per day. The week in course predictor has a type of factor. In this example, there are sixteen weeks in the course, so the trainer expands the week in course predictor into 15 indicator variables as described above. The cumulative proportion points earned out of cumulative points attempted predictor has a type of numeric and uses a transformation that requires scaling. The proportion days logged in predictor also has a type of numeric and requires scaling. The average posts per day predictor has a type of numeric and uses transformation that requires centering by course and scaling. In addition, two-way interaction terms are used.

The design matrix includes a row for every enrollment day. Each enrollment day is associated with a particular course ID, a user ID that identifies a particular student, and a day in the course. If a student drops a course, then there is no data for that student for the days following the drop. The matrix also includes a column for every dummy variable, a column for each numeric variable, a column for each interaction term, and a column for the intercept term. The outcome vector includes a single column with a row for every enrollment day. The values in the outcome vector indicate the success or failure of the particular students represented in the enrollment day records. The value may be 1 if the student successfully completed the class and may be 0 if the student failed or dropped the class.

This example uses lasso logistic regression to determine the coefficient values for each predictor, as described above in connection with equation (4). Table 2 below illustrates the coefficient values for the predictors for this example.

| Term | Value |
|---|---|
| (Intercept) | 0.98 |
| Week_f2 | −0.18 |
| Week_f3 | −0.49 |
| Week_f4 | 0.05 |
| Week_f5 | 0.15 |
| Week_f6 | 0.04 |
| Week_f7 | 0 |
| Week_f8 | 0 |
| Week_f9 | −0.04 |
| Week_f10 | −0.20 |
| Week_f11 | −0.30 |
| Week_f12 | −0.42 |
| Week_f13 | −0.62 |
| Week_f14 | −0.73 |
| Week_f15 | −0.80 |
| Week_f16 | −0.80 |
| CumulativePointsProportion_s | −2.75 |
| ProportionDaysLoggedIn_s | −0.56 |
| AveragePostsPerDay_c_s | −0.31 |
| Week_f2: CumulativePointsProportion_s | 1.88 |
| Week_f3: CumulativePointsProportion_s | 2.38 |
| Week_f4: CumulativePointsProportion_s | 0.69 |
| Week_f5: CumulativePointsProportion_s | 0.11 |
| Week_f6: CumulativePointsProportion_s | 0 |
| Week_f7: CumulativePointsProportion_s | −0.30 |
| Week_f8: CumulativePointsProportion_s | −0.99 |
| Week_f9: CumulativePointsProportion_s | −1.05 |
| Week_f10: CumulativePointsProportion_s | −1.00 |
| Week_f11: CumulativePointsProportion_s | −1.02 |
| Week_f12: CumulativePointsProportion_s | −0.97 |
| Week_f13: CumulativePointsProportion_s | −0.87 |
| Week_f14: CumulativePointsProportion_s | −0.91 |
| Week_f15: CumulativePointsProportion_s | −1.16 |
| Week_f16: CumulativePointsProportion_s | −1.27 |
| Week_f2: ProportionDaysLoggedIn_s | 0.07 |
| Week_f3: ProportionDaysLoggedIn_s | 0 |
| Week_f4: ProportionDaysLoggedIn_s | 0.12 |
| Week_f5: ProportionDaysLoggedIn_s | 0.05 |
| Week_f6: ProportionDaysLoggedIn_s | 0 |
| Week_f7: ProportionDaysLoggedIn_s | 0 |
| Week_f8: ProportionDaysLoggedIn_s | 0 |
| Week_f9: ProportionDaysLoggedIn_s | −0.01 |
| Week_f10: ProportionDaysLoggedIn_s | −0.06 |
| Week_f11: ProportionDaysLoggedIn_s | −0.09 |
| Week_f12: ProportionDaysLoggedIn_s | −0.13 |
| Week_f13: ProportionDaysLoggedIn_s | −0.16 |
| Week_f14: ProportionDaysLoggedIn_s | −0.15 |
| Week_f15: ProportionDaysLoggedIn_s | −0.18 |
| Week_f16: ProportionDaysLoggedIn_s | −0.10 |
| Week_f2: AveragePostsPerDay_c_s | 0 |
| Week_f3: AveragePostsPerDay_c_s | −0.10 |
| Week_f4: AveragePostsPerDay_c_s | 0 |
| Week_f5: AveragePostsPerDay_c_s | 0 |
| Week_f6: AveragePostsPerDay_c_s | 0 |
| Week_f7: AveragePostsPerDay_c_s | 0 |
| Week_f8: AveragePostsPerDay_c_s | 0 |
| Week_f9: AveragePostsPerDay_c_s | 0 |
| Week_f10: AveragePostsPerDay_c_s | 0 |
| Week_f11: AveragePostsPerDay_c_s | 0 |
| Week_f12: AveragePostsPerDay_c_s | 0 |
| Week_f13: AveragePostsPerDay_c_s | 0 |
| Week_f14: AveragePostsPerDay_c_s | 0 |
| Week_f15: AveragePostsPerDay_c_s | 0 |
| Week_f16: AveragePostsPerDay_c_s | 0 |
| CumulativePointsProportion_s: ProportionDaysLoggedIn_s | −0.39 |
| CumulativePointsProportion_s: AveragePostsPerDay_c_s | 0 |
| ProportionDaysLoggedIn_s: AveragePostsPerDay_c_s | 0 |

A zero value indicates that a predictor has been eliminated. For example, during week seven (Week_f7) and week eight (Week_f7) in the course, there was no change in risk relative to the week in the course. There are also a number of two-way interaction predictors (e.g., Week_f6:CumulativePointsProportion_s, Weekf2:AveragePostsPerDay_c_s) with zero values. The values for the coefficients are used in equation (1) to generate a risk assessment model.

### Component Models

The model described above is directed to assessing the overall risk that a student will fail or drop a course. In addition to creating models that assess overall risk, the trainer can also create component models that may provide more insight into the risk assessment. A component model may be based on multiple predictors that are related to a certain aspect of risk. As discussed above, each predictor is associated with a component. In one implementation, the component models include models directed to performance, participation, attendance, timeliness and student profile. Predictors related to points and number of submissions may be used to create a component model for performance. Predictors related to frequency and recency of log-ins may be used to create a component model for attendance. Predictors related to enrollments in previous courses, past successes or failures, the program in which the student is enrolled, and demographic information for the student may be used to create a component model for student profile.

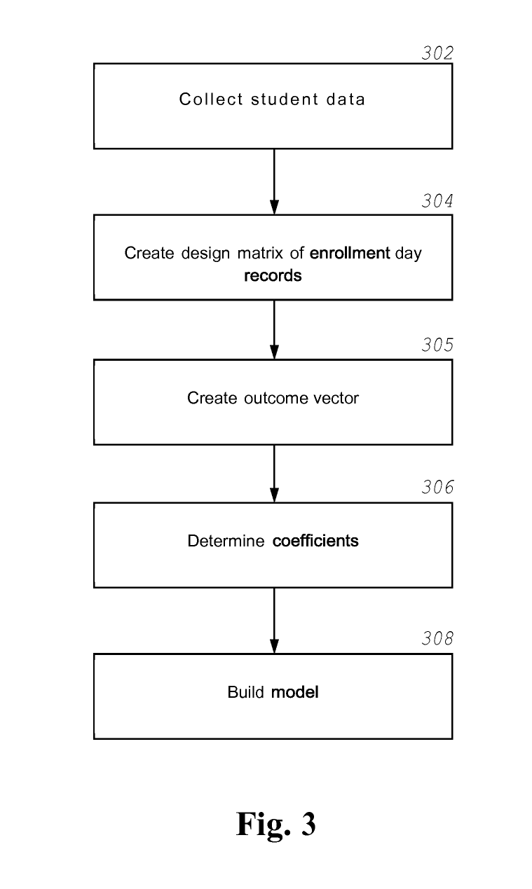

FIG. 3 summarizes the methods for creating a risk assessment model or a component model using automated predictor selection. The method begins at 302 where the system collects historical student data. The student data may be collected from an LMS or from any other system that includes student information. At 304 the system builds a design matrix using the historical student data. The system uses predictor specifications to determine whether a predictor needs to be transformed or expanded before being added to the design matrix. If n-way interactions are used, then the system also includes interaction terms in the matrix. At 305 the system builds an outcome vector for the design matrix. The outcome vector indicates the success or failure of the students represented in the historical student data. At 306, the system determines the coefficient values for the model using an automated predictor selection method. Each predictor is associated with a coefficient. At 308 the system builds the model using the coefficients. In some instances the coefficient values may shrink to zero, but in other instances the coefficient values do not. In either instance, the relative values of the coefficients indicate the relative relevancy of the predictor or interaction term to the assessment of risk.

### Scorer

Typically, an LMS updates current student data on a daily basis. The data integrator collects data from the current student data and processes it into a scoring data set. The collection of the current student data may occur at a predetermined interval or may be on demand. The scorer receives the scoring data set from the data integrator and the model from the trainer. The scorer creates a design matrix from the scoring data set for use with the model. If a predictor specification indicates that a predictor is to be scaled, then the scorer uses the mean or standard deviation calculated for the training data set for the scaling. It does not use the mean or standard deviation of the current student data. The scorer uses the appropriate model generated by the trainer to assess student risk. For example, if the current student data is related to a point in the course where the students have not yet had an opportunity to earn points, then the scorer uses the model that does not use points. The output of the scorer is a risk estimate or probability having a value between zero and one for each enrollment day record.

The scorer may use risk binning to translate a numeric risk estimate into a coarser-grained representation of risk. One exemplary system uses a k-means clustering algorithm to assign risk estimates to one of k bins. K-means clustering creates groups based on a particular data distribution. If k=3, then three bins are created for low, medium, and high risk.

### Output

The output from the scorer can be presented to a user in any number of ways. The presentation may vary based on whether the user is a student, an instructor, or an institution, as well as on user provided preferences. The output of the scorer may be presented on an individual student basis, on a course basis, or on a risk basis.

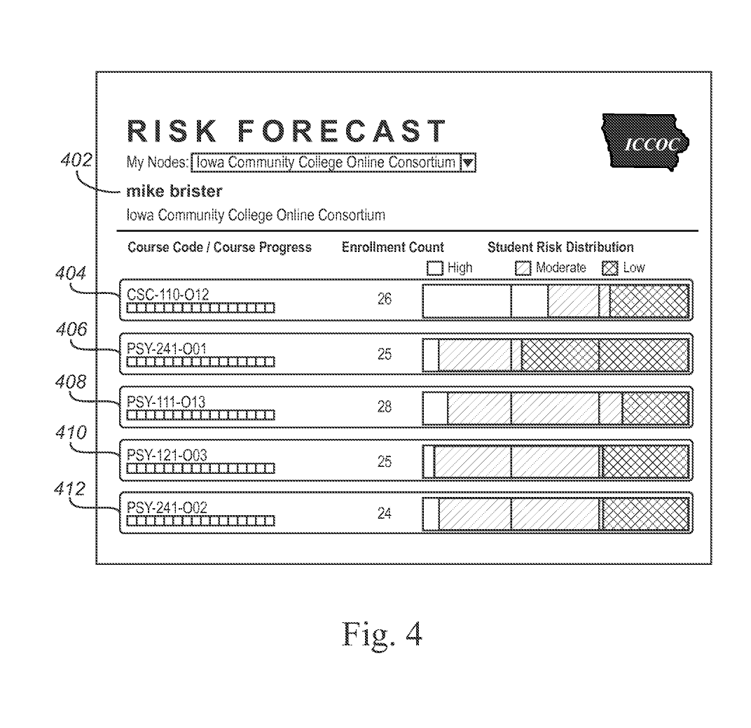

FIGS. 4-7 illustrate possible options for presenting the output of the scorer to an instructor. FIG. 4 illustrates an exemplary page for an instructor. The instructor is identified by name 402 and the page lists the courses 404, 406, 408, 410, 412 taught by the instructor. For each course, the page shows the course code (e.g., CSC-110-O12) or other identifying information, the number of students enrolled in the course (Enrollment Count) and the risk distribution for the students in each course. The exemplary risk distribution shown in FIG. 4 groups students into low, medium and high risk categories. For example, the page shows that the majority of the 26 students in CSC-110-O12 have a high risk of dropping or failing the course, whereas the majority of the 25 students in PSY-241-O01 have a moderate risk of dropping or failing the course.

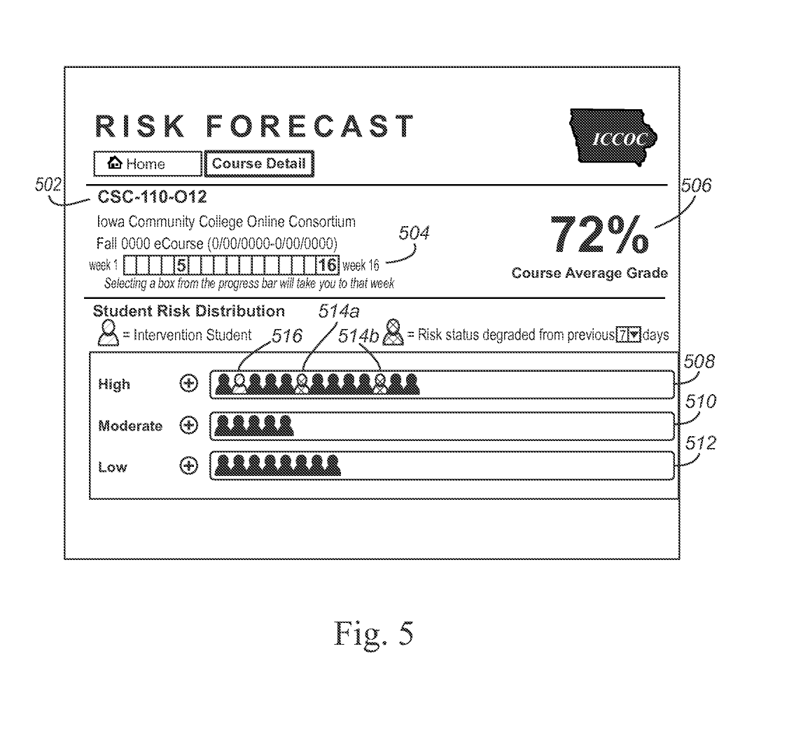

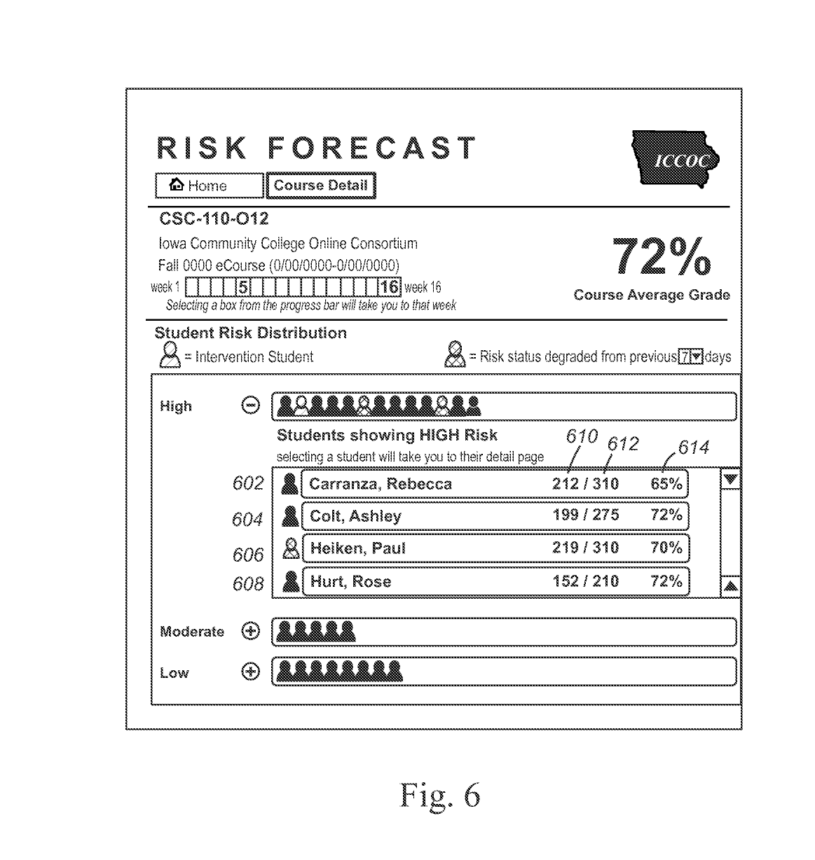

FIGS. 5 and 6 illustrate exemplary course detail pages that provide details for one of the courses listed in FIG. 4. The page shown in FIG. 5 includes the course code or other identifying information 502, the week in the course 504, the course average grade 506, and the number of students in each risk category. In addition, the page shows some student-specific information, such as identifying a student who has moved from a lower risk category to a higher risk category 514a, 514b and identifying a student who has received an intervention 516. An intervention is typically a communication from the instructor to the student to inquire about the student's performance in the course.

FIG. 6 illustrates that the risk categories can be expanded to provide additional information about the students in the selected risk category. The information shown in FIG. 6 includes the student's names 602, 604, 606, 608, the points earned by the student 610, the possible points 612, and the student's course grade 614. The information also includes student-specific information, such as identifying a student who has moved from a lower risk category to a higher risk category or identifying a student who has received an intervention.

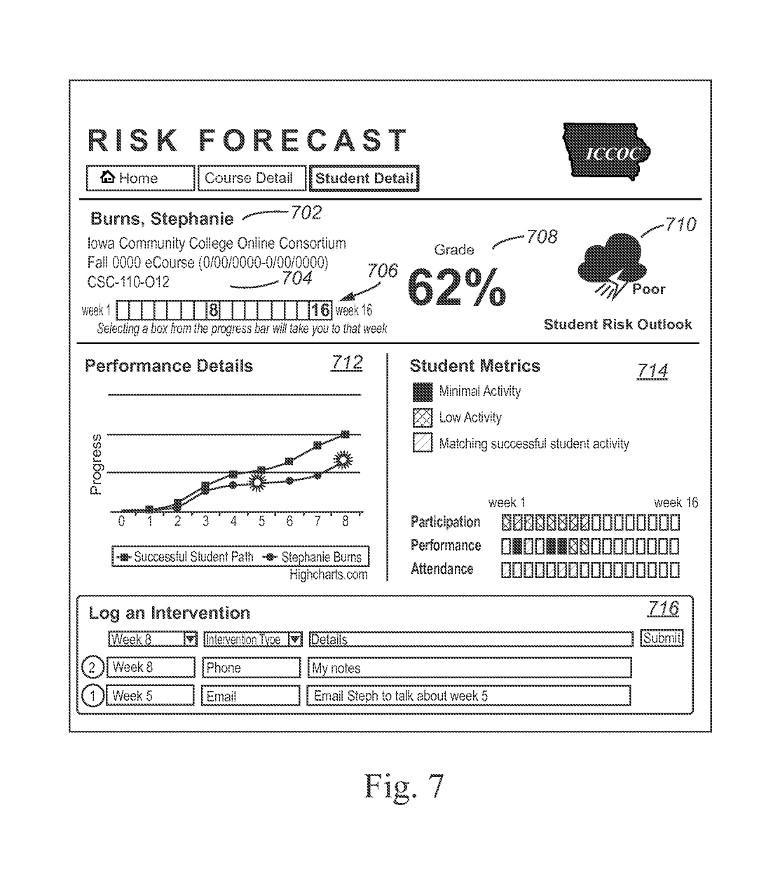

FIG. 7 illustrates a student detail page that provides details about a specific student. The page includes the student's name 702, course identifying information 704, the week in the course 706, the student's grade in the course 708, and the student's risk outlook 710. In addition, the page compares the student's performance with the performance of other students in the course that have a low risk of failing or dropping the course. The performance details 712 compare the points earned by the student with the points earned by students with a low risk of failing or dropping the course. The student metrics 714 are related to the component models and help to explain the reasons behind the student's risk outlook. For example, FIG. 7 illustrates that the student's risk outlook is probably due to the student's participation and performance instead of the student's attendance. FIG. 7 also illustrates the interventions 716 for the student. The first intervention was in week 5 and included an e-mail from the instructor. The second intervention was in week 8 and included a phone call from the instructor.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other storage devices, transmission devices, or display devices of the computing platform.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific aspects thereof, it will be appreciated that those skilled in the art, upon attaining an understanding of the foregoing, may readily produce alterations to, variations of, and equivalents to such aspects. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method for creating a model to assess student risk, comprising:
collecting historical student data for a plurality of students wherein the historical student data includes historical student data associated with a plurality of courses directed to a same subject and associated with a plurality of predictors of student risk;
creating a design matrix by:
organizing the historical student data on an enrollment day basis so that historical student data associated with the predictors is associated with one of the courses, one of the students, and one of the days within the one of the courses; and
transforming the historical student data associated with at least one predictor;
creating an outcome vector so that outcomes are associated with the historical student data organized on an enrollment day basis;
determining coefficient values for the plurality of predictors using logistic regression, the design matrix, and the outcome vector; and
using the coefficient values to create a model to assess student risk, wherein the model is configured to generate an outcome probability for a student in an on-going course using current student data.

2. The method of claim 1, wherein transforming the historical student data associated with at least one predictor comprises using a course identifier, a historical course average, a historical course mean, or a historical standard deviation to modify the student data.

3. The method of claim 1, wherein creating a design matrix further comprises:
creating interaction terms for the design matrix, wherein the interaction terms represent a relationship between multiple predictors.

4. The method of claim 1, wherein a predictor specification for each predictor defines whether student data associated with the predictor is transformed.

5. The method of claim 1, further comprising creating a component model by:
selecting predictors from the plurality of predictors that are associated with a selected component;
creating an additional design matrix using historical student data for the selected predictors;
creating an additional outcome vector;
determining coefficient values for the selected predictors using logistic regression, the additional design matrix, and the additional outcome vector; and
using the coefficient values for the selected predictors to create a component model to assess the selected component of student risk.

6. The method of claim 1, wherein applying logistic regression to the design matrix comprises applying one of the following: lasso logistic regression, forward step-wise regression, or backward step-wise regression.

7. The method of claim 1, further comprising:
collecting current student data for a second plurality of students, wherein the current student data includes current student data associated with at least one course directed to the same subject and associated with the plurality of predictors of student risk;
creating a second matrix by:
organizing the current student data on an enrollment day basis so that current student data associated with the predictors is associated with the at least one course, one of the second plurality of students, and one of the days within the at least one course; and
transforming the current student data associated with the at least one predictor; and
applying the model to assess student risk to the second matrix to generate an outcome probability for each of the students in the second plurality of students.

8. The method of claim 7, wherein transforming the current student data associated with the at least one predictor, comprises using a historical course average, a historical course mean, or a historical standard deviation to modify the current student data.

9. The method of claim 1, further comprising:
presenting the outcome probability to a user via a computer-implemented user interface.

10. The method of claim 1, wherein each of the plurality of predictors has an associated type, and wherein creating a design matrix further comprises expanding at least one predictor having a type of factor into a set of indicator variables, wherein each indicator variable has an associated value that represents a level of the factor.

11. A system for creating a model to assess student risk, comprising:
a data integrator configured for collecting historical student data for a plurality of students to create a training data set, wherein the historical student data includes historical student data associated with a plurality of courses directed to a same subject and associated with a plurality of predictors of student risk, and for collecting current student data for a second plurality of students to create a scoring data set, wherein the current student data includes current student data associated with a course directed to the same subject and associated with the predictors;
a trainer configured for receiving the training data set and for:
creating a design matrix using the training data set by organizing the historical student data on an enrollment day basis so that historical student data associated with the predictors is associated with one of the courses, one of the students, and one of the days within the one of the courses;
creating an outcome vector so that outcomes are associated with the historical student data organized on an enrollment day basis;
determining coefficient values for the plurality of predictors using logistic regression, the design matrix and the outcome vector; and
using the coefficient values to create a model to assess student risk, wherein the model is configured to generate an outcome probability for a student in an on-going course; and
a scorer configured for receiving the scoring data set and for:
creating a second matrix using the scoring data set by organizing the current student data on an enrollment day basis so that current student data associated with the predictors is associated with the at least one course, one of the second plurality of students, and one of the days within the at least one course; and
applying the model to assess student risk to the second matrix to generate an outcome probability for each of the students in the second plurality of students.

12. The system of claim 11, wherein the trainer is further configured to transform the historic student data associated with at least one predictor by scaling the historic student data based on at least one of the following: a course identifier, a historical course average, a historical course mean, or a historical standard deviation.

13. The system of claim 11, wherein each of the plurality of predictors has an associated type, and wherein the trainer is further configured to create the design matrix by expanding at least one predictor having a type of factor into a set of indicator variables, wherein each indicator variable has an associated value that represents a level of the factor.

14. The system of claim 11, wherein the trainer is further configured to create interaction terms for the design matrix, wherein the interaction terms represent a relationship between multiple predictors.

15. The system of claim 11, wherein the scorer is further configured to transform the current student data associated with at least one predictor by scaling the current student data based on at least one of the following: a historical course average, a historical course mean, or a historical standard deviation.

16. The system of claim 11, wherein the trainer uses one of the following to determine the coefficient values: lasso logistic regression, forward step-wise regression, or backward step-wise regression.

17. The system of claim 11, further comprising a data store configured for storing the model and at least one of the following: a historical course average, a historical course mean, or a historical standard deviation.

18. A computer-readable medium having computer executable instructions for:
collecting historical student data for a plurality of students, wherein the historical student data includes historical student data associated with a plurality of courses directed to a same subject and associated with a plurality of predictors of student risk;
creating a design matrix by:
organizing the historical student data on an enrollment day basis so that historical student data associated with the predictors is associated with one of the courses, one of the students, and one of the days within the one of the courses; and
transforming the historical student data associated with at least one predictor;
creating an outcome vector so that outcomes are associated with the historical student data organized on an enrollment day basis;
determining coefficient values for the plurality of predictors using lasso logistic regression and the design matrix; and
using the coefficient values to create a model to assess student risk, wherein the model is configured to generate an outcome probability for a student in an on-going course.

19. The computer-readable medium of claim 18, wherein each of the plurality of predictors has an associated type, and wherein creating a design matrix further comprises expanding at least one predictor having a type of factor into a set of indicator variables, wherein each indicator variable has an associated value that represents a level of the factor.

20. The computer-readable medium of claim 18, wherein the plurality of predictors of student risk include predictors related to points earned and log-in time.
